(19) United States
(12) Patent Application Publication
(10) Pub. No.: US 2010/0229234 A1
(43) Pub. Date: Sep. 9, 2010

(54) SYSTEMS AND METHODS FOR DETECTING AND PREVENTING DENIAL OF SERVICE ATTACKS IN AN IPTV SYSTEM

(75) Inventor: Alan Rouse, Lawrenceville, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Tandberg Television Inc.

(21) Appl. No.: 12/397,004

(22) Filed: Mar. 3, 2009

(51) Int. Cl. G06F 17/00; G06F 11/00

(52) U.S. Cl. 726/11; 726/23

(57) ABSTRACT

An intrusion protection system is disclosed for an Internet based television service (IPTV) that detects unexpected conditions, including rogue terminals sending unexpected message. The system comprises one or more firewalls that may implement a mirrored state machine which is specific to an application level protocol. The state machine is typically maintained for each user, and each message from a user may be analyzed to determine if it is an expected message. The message may also be analyzed to determine if it represents an unusual volume of messages from the user or otherwise represents some other unusual aspect associated with a rogue terminal or terminals. Information regarding unusual events are reported from the firewall to an intrusion protection system which can further analyze the events, other data, and report possible attacks to a network operations center.

### FIELD OF INVENTION

The present invention generally related to Internet Protocol television (“IPTV”) systems, and related systems and methods which include the detection, reporting, and preventing denial of service requests or other nefarious actions from users on the network.

### BACKGROUND OF THE INVENTION

The Internet is regularly used to provide users access to real time video. Some cable service providers are even using IP based infrastructure for delivering video over closed cable systems to their subscribers, and the next step in the evolution is to use an open IP network (e.g., the Internet) for providing access to television services. Thus, viewers would use a computer or other suitable device for establishing necessary connections for viewing television, movies on demand, or other such multi-media services. In this context, such services can be broadly described as television services, and an IPTV network is one that adapts to using the Internet to provide such services on an open basis. If an IPTV network incorporates the Internet, then portions of the IPTV network are considered open and readily accessible to Internet users.

IPTV systems rely upon messaging originating from a source—client devices at the viewer's premises to select and order content, and to generally control the viewing experience. Various communication protocols are used by the client to navigate a catalog of available content in order to select content, and to perform any transactions necessary to enable viewers to order and purchase viewing rights. Once content has been ordered, and a session established, the viewing session can be controlled by the viewer using another protocol, such as either the Real Time Streaming Protocol (RTSP) or Lightweight Stream Control Protocol (LSCP). In an IPTV network, these control messages originate from client devices in the viewer's premises, and are communicated over an IP network in whole or in part to servers in the video system for processing. There, the servers provide the necessary functionality.

Assuming an open IP network (e.g., Internet) is used, access to the IPTV network is not inherently limited to only subscribers or authorized viewers. In the past, cable systems were “closed”, meaning only users obtaining authorized set top boxes or other permissions could access the cable network. More specifically, in an IPTV network, non-subscribers may attempt to access IPTV services. Consequently, IPTV networks may be subject to various types of abuse from equipment that is not under the control of the network owner. In particular, a video system delivering IPTV services to the general public may be vulnerable to attack from one or more rogue devices attached to the network in viewers' homes or computers from other users which have access to the IPTV network. Further complicating matter, attacks from network controlled equipment can occur that have been taken over by malware or other unforeseen vulnerabilities. IPTV systems delivering content over the public Internet are especially at risk because they are exposed to vast numbers of PC's and other devices which might be used by an attacker to conduct a distributed denial of service attack (DDoS). Because the operation of many of the network elements (such as VOD servers) are fully automated, a failure of an element may be reported and detected at a central operations center, but the cause may not be initially known to network personnel. In addition, reporting a failure after the fact does not provide a proactive indication that a problem such as overloading of a network element is occurring. Therefore, in order to properly manage and provide IPTV service over an IPTV network, systems and methods are required to detect, report, and prevent nefarious requests from such rogue devices from adversely impacting service to authorized viewers.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one embodiment of an intrusion protection system comprising application specific firewalls;

FIG. 2 illustrates a typical mirror state machine;

FIG. 3 illustrates one embodiment of a firewall;

FIG. 4 illustrates one physical embodiment of the firewall; and

FIG. 5 illustrates one embodiment of the processing of the mirror state machine.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

As used herein, the term “television services” is broadly intended to encompass any offered services available to customers of cable service providers, whether it be providing network television, cable television programs, video on demand, etc. Further, this is independent of any particular transport technology. When providing television services using in whole or in part an open network, such as the Internet, it is necessary to anticipate rogue devices sending unanticipated messages. A “rogue” device is broadly intended to encompass devices of various types which send unauthorized or unexpected messages, which includes:
1) a device operated by an authorized user, but which device is defective or otherwise operates in an improper manner that is unintended, whether due to malicious programming from the user or otherwise, and
2) a device operated by an unauthorized user which is operating in a manner intended by the user, but for purposes of obtaining information or services in an unauthorized manner.

In either case, unanticipated messages (either in volume of messages or in the type or contents of messages) are generated from a device and received in the IPTV service provider. An “authorized user” is typically a subscriber of a service provided from the service provider, whereas an “unauthorized user” is typically a person that is not a subscriber, but is attempting to interact with the service provider for obtaining information (e.g., “probing” the service provider) or otherwise causing harm. A “user” may be either an authorized or unauthorized user.

In a Denial of Service Attack, (“DOS attack”) attack, a rogue device sends a large volume of messages to a server, rendering it unable to respond to legitimate messages. Because of the scale of the equipment used by the IPTV service provider, a single rogue device may not be able to overwhelm the server in the cable system provider. However, those architecting a denial of service attach are often able to covertly enlist use other devices to amplify their attack. This may be accomplished by sending a virus program to the other devices, which are programmed to coordinate sending messages. Thus, a Distributed Denial of Service Attack (“DDOS”) is created. Such attacks often result in a denial of service to legitimate clients because the legitimate users' messages cannot get through to the server, or if received, the server cannot respond to their requests in a timely fashion due to the large volume of messages. In another approach, a relatively low volume of messages can be sent which resulting in the target system consuming internal resources to an extent that prevents the target system from being able to service regular user requests.

Other types of attacks may also be possible, exploiting weaknesses in protocols or in the exposed interface software in the video system. For example, unauthorized users may generate variations of the same message type and evaluate the responses in an attempt to identify a recognizable message or a parameter in a message. These attacks might result in a denial of service for legitimate users, or in some unauthorized manipulation of the video system.

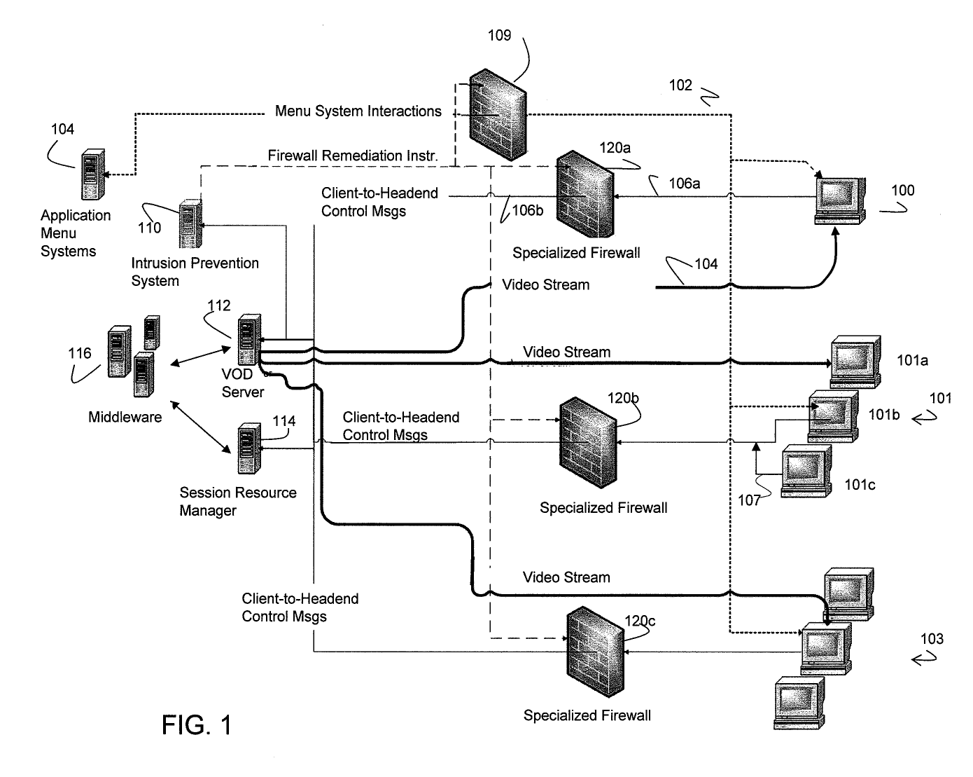

The approach for mediating the impacts of such unauthorized access involves utilization of an intrusion prevention system (“IPS”) which coordinates specialized firewalls located throughout the network. A basic overview of an IPTV based service provider providing VOD services is shown in FIG. 1.

In FIG. 1, the users 100, 101, 103 are illustrated as computers, but could also be televisions adapted for Internet access. Such devices could involve a specialized set top box, an interface from a computer to the television, or some other arrangement. In FIG. 1, different clusters of users may be grouped based on geography or other considerations. For example, user 101 could represent users in one city and users 103 could represent users in another city, which is typical if the service provider provides services in various localities.

Further, the “user” as referenced is not so much a person (the viewer), but the device generating messages under control of the viewer. Thus, with this definition, it is not significant whether the device is a computer, television, set top box, or other electronics device.

The users 100, 101, 103 are illustrated as accessing various services and having different types of interaction. For purposes of illustration, viewer 100 is used to illustrate the purposes of the invention and has various interactions occurring. Obviously, other users will have different status of levels of interaction at any given time, and the normal context of interaction depends on the particular service involved. As noted above, the principles of the invention will be shown in the context of a VOD service, but other services can be used to illustrate application of the invention.

Viewer 100 is shown as receiving a video stream 104 from a VOD server 112. The transport of the video stream in an IPTV network typically occurs using an IP protocol, which may be sent over public networks (Internet) or a combination of private and public access IP networks. For example, the service provider may use cable technology for transmission of video streams at the ‘back end’ and use IP transport mechanisms for distributing video stream data 104 to the user.

In order for the user to have selected the video presently being viewed, the user 100 would have had to previously requested and selected a video. Thus, a user would typically interact with an application menu system 104. The application menu system provides the user-interface via messaging 102 with the user 100. A variety of types of interaction systems may be used to convey the titles the user may select from, and the most common method used is a simple linear (e.g., alphabetical) listing of available titles from which the user selects from. Other user selection interfaces can be used, which allow searching of selections based on user indicated criteria such as type of movie, year, actors, etc. as well as systems that provide recommendations based on past movie selections, demographics, etc. Typically, the messaging 102 is carried on a distinct IP identified traffic connection or link between the user and the application menu system.

Once the user has selected a movie and a session is established, other interactions may occur between the user and the service provider. For example, once the movie is being viewed, the user may invoke various functions controlling the playing of the video. These are sometime referred to as “tick” mode functions, and correspond roughly to functions found on a VCR such as “pause”, “play”, “rewind”, “fast-forward”, and “slow motion.” Other functions may be included or removed from this set. Regardless of the specific functions involved, the user invokes the functions by sending control messages 106 to a headend system, which in FIG. 1 is illustrated as VOD server 112. The “type” of message refers to what function or control is conveyed by the message. Thus “pause” and “play” are both control messages, but are different types of control messages.

It is also possible that certain control messages 106 may be sent by a user to different entities at different times. For example, in the above example, the user may interact first with the application menu system to select a movie, and then interact with a VOD server to control the playing of the selected movie. In some embodiments the message conveyed from the user identifying a selection may be sent to a session resource manager 114. The session resource manager 114 performs various functions associated with initially establishing a session for viewing a video, such as ensuring the user is authorized, that network resources are available and then assigning them, etc. Once the session is established (e.g., the video is streaming to the viewer), the trick mode function messages would be sent and processed by the VOD server. The above illustrates that the functions required to establish a VOD session versus controlling an established VOD session are slightly different. Consequently, two separate network entities may be involved. Other embodiments may integrate the functions of the VOD server 112 and the session resources manager 114.

Further, other systems 116 may be required to accomplish the functions. For example, if establishing a VOD session requires verifying the credit status and then billing the viewer for such, then billing system and other middleware systems 116 may be involved. However, the user typically does not normally directly interact with such systems.

The control messages 106 are also carried on an Internet connection, which typically may be conveyed on the Internet infrastructure (not explicitly shown in FIG. 1). The control messages can also be conveyed in part on a cable distribution system, and/or other infrastructure for transporting the control messages.

If the infrastructure for conveying the information were a closed network, this would reduce, but not eliminate the need for detecting rogue devices. However, in an open network, the likelihood of rogue devices attempting to interact with the service provided is much more likely. For example, user 101c may not be an authorized subscriber of any service, but may nonetheless generate messages 107 attempting to interact with the headend.

The control messaging between the user and the network controller can be based on various protocols. Two such examples are the Real Time Streaming Protocol and the Lightweight Stream Control Protocol.

The Real Time Streaming Protocol (“RTSP”) is an Internet based protocol defined in a document known as Request for Comments: 2326 (“RFC 2326”) which is an application level protocol for controlling on-demand of real-time streamed data (e.g., audio and video). The Lightweight Stream Control Protocol (“LSCP”) was created by cable oriented entities to provide a protocol to mimic an interactive VCR like control ability for VOD streams.

The service provider determines which protocols are used for interacting with the appropriate servers and network elements for providing the television services. These application level protocols define certain message formats, parameters, and procedures for controlling the VOD stream. The protocols define also certain procedures that must be used. In other words, not only must messages conform to a certain structure and contents, but the messages themselves can only be sent at certain times and in response to other specific messages. A high level example illustrates this requirement: it does not make sense for a user to send a message to terminate a video if no video were previously select.

Thus, messages can only be sent at certain times. If a message was sent requesting playing a video, then it makes sense to send a message to pause the video. Sending a control message causes the VOD server to perform a certain action and this condition can be described as a “state.” For example, when the VOD server is sending video, it can be described as in the “streaming” state. The various states of a VOD server can be modeled as a state machine. A state machine is a data representation of the state of operation of a system, wherein each state defines a unique set of operating conditions of the system. Each state can be given a number or other descriptor, such as “State 1” or “Streaming State”.

Similarly, a VOD server can have a set of states. One state previously identified is when the VOD is streaming video, which can be defined as a “streaming” state. If the VOD stream is paused, then the server could be defined as being in a “paused” state. Since the states of the VOD server are controlled by messages, the protocol itself may be modeled as having a state. If operating correctly, the protocol state and the VOD server state should be aligned. For example, if a “play” command message is sent, the protocol state machine would usually move into “streaming state” and the VOD server would also be in a “streaming” state. Thus, a command protocol message requesting to “stream” the video would result in the VOD server streaming the video. The state machine associated with the protocol would be in the “streaming state.” Although a number of states are possible, only one of the states is current. In other words, only one current state is allowed.

Because the services have certain possible modes of operations, only certain messages may be expected in certain states. Thus, the protocol itself can have a number of states where certain messages are expected, and other messages are not. For example, if a user sends a “pause” command, the service may placed in a “paused state.” It makes sense that the next message may be a “resume” commands, but it is not expected that the next command message would be another “pause” command. Even less likely would be a command to select a video, since one is already being viewed. Of course, if an expected command is sent, it should not cause the service to crash. Continuing with the example, since the service is already is a “paused” state, receiving a “pause” message will not change the state of operation. However, the receipt of a second “pause” command may indicative of a rogue device.

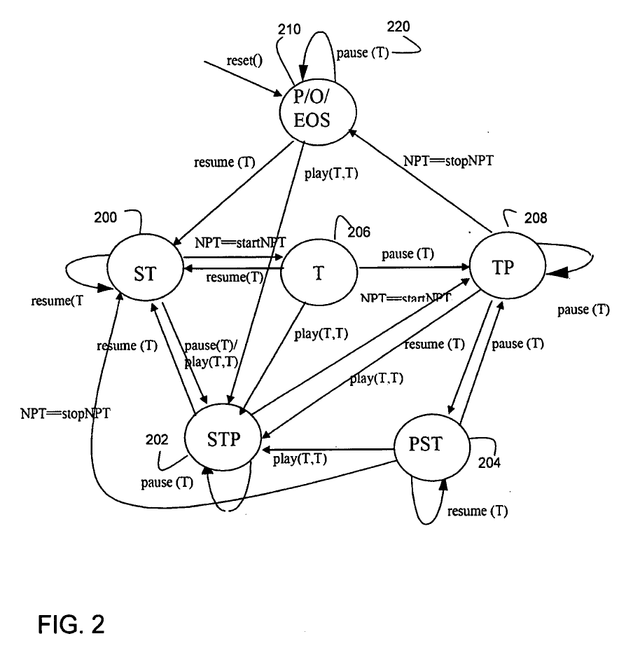

One representation of the state machine is shown in FIG. 2. In FIG. 2a the circles 200, 202, 204, 206, 208, 210 represents the states of the VOD service. States are changed by receipt of a command message from the user device. FIG. 2b discloses a chart indicating the corresponding meaning of the state descriptor. For example, in state 206 “T”, which is when the VOD is streaming the video to the user, receipt of a “pause” command will migrate the VOD server to the state TP 208. This is the “transport pause” state which indicates that the server has paused a particular video stream.

Thus, consider state 210, which corresponds to three states, but which have the same behavior. This state corresponds to when there is no video being streamed. Specifically, if the user has not selected a stream, then it is in the “O” for “open” state. If the server has paused a stream, and hence is no longer streaming it, it is in the “P” for “paused” state. If the server has reached the end of a video, it is in the “EOS” or “end of stream” state. In any case, there is no video presently being streamed. Thus, in this state is not possible to pause a presently streaming video. Correspondingly, it is not possible to move from state P/O/EOS 210 to state TP 208. Receipt of a “pause” message would not be expected, and it does not change the current state. Note that it is possible to first stream a video by migrating to state 200 ST and then to state T 206, which represent a streaming state. Then it is possible to move to state TO 208. Thus, it is possible to define certain procedures and associated commands to cause movement from one state to another.

The VOD server must anticipate such unusual conditions, and the VOD server designers must ensure the VOD server does not crash in such a condition. However, the VOD equipment is not necessarily able to distinguish between an occasional errant command message and a deliberate attempt by a rogue device to send unexpected messages. It is possible to create a separate software application in a device called a firewall that mirrors the state machine of the VOD service and records unexpected and unusual messages from a user. The firewall can distinguish between the occasional errant message and a rogue device, and can detect report, and block command messages from a rogue device.

There are any number of unusual conditions that may occur in terms of messages sent from a user (specifically a rogue device), and it is not possible to list every possible scenario. Hence, a few are identified to illustrate conditions which can be noted as unusual.

In one scenario, a user repeatedly sends the same message. For example, returning to the receipt of a “pause” message, it is expected that a subsequent message would be “play” or “resume”. However, it would be most unusual for the user to send another “pause” message, especially on a repeated basis. Specifically, it would be unusual for a device to send ten (or one hundred messages) all of the same type. Repeatedly sending the same message would be indicative of a rogue device. Further, repeatedly sending a large number of the same messages rapidly (in a short time interval) can be indicative of a rogue device.

In a second scenario, the rogue device may send the same message repeatedly, but with a different parameter. For example, if a message requires a certain parameter, such as a transaction identifier or other identifier, the rogue device may send the same message repeatedly, but time each with a different identifier. The messages containing an unrecognized parameter by the server may be rejected. The source device may be able to recognize this either by an explicit error response from the server, or by the server failing to send a positive acknowledgment. However, once the control message using a proper identifier is received by the VOD server, it may send an acknowledgement message to the device, so that the rogue device now knows which identifier is proper to use.

In a third scenario, messages may be sent which are by themselves in the proper order, but which represent an unexpected situation because of timing. For example, it is expected that users may “pause” and “resume” a video. However, there is typically a certain time period involved. Users typically would not “pause” a movie for a fraction of a second. In another example, users would not repeatedly and immediately transmit a “pause” after sending a “resume.” However, it is possible to imagine that a first user would disrupt service provided to a second user by sending message impersonating the second user indicating a “pause” message. The second user may send a “resume” command in order to restore service. Thus, the unexpected sequence of messages may occur as a result of a rogue device.

In a fourth example, a server may receive a command requesting a movie, and upon receiving positive acknowledgement, the server receives a message immediately canceling the request. This process may be repeated, so that it appears the user is constantly requesting a different movie. Typically, a user selecting a movie would desire to view at least a portion of the movie. Alternatively, a user selecting one movie may change their mind, but repeatedly changing their mind in a short time is likely to be suggestive of a rogue device. Thus, a rate limiter may be incorporated allowing a viewer to invoke expected messages at a certain rate. The rate should be a settable parameter, and could be set based on the command. For example, with respect to requesting a video, the parameter could allow a viewer to request no more than one video per minute. In other embodiments, the rate could be defined irrespective of message type. For example, a user would be limited to no more than 10 messages in 15 seconds.

In a fifth example, the server receives a command for requesting a movie from a user, and then receives another request form the same user requests for another movie, but without completing or terminating the first request. The service provider may limit the user to viewing only one video at a time, and thus may automatically reject a service request if the service is already being provided to the same user. While it is possible that two viewers in the same household could simultaneously request viewing different videos, this limit is predicated on the user viewed as a singular device or message source.

In a sixth example, a rapid repetition of commands, such as “fast forward, rewind” or “play-stop-play-stop” may be send by a user. Alternatively, a random set of messages may be sent from a user. In either case, the user is attempting to consume network resources and/or interfere with the present streaming of a video. These can be detected by maintaining a message sequence counter, or otherwise limiting a number of messages in a time period from a user.

In a seventh example, a rogue device may probe for weaknesses in a server, or otherwise attempt to divert a video stream. In this attack, a rogue device records legitimate message exchanges in a particular conversation, and then replays the conversation at a later time. So, a customer may order a movie, and an eavesdropper records the packets. At a later time, the attacker replays the packets to order the movie again in the name of the original customer. Variants of this attack might be used in an attempt to order a different movie, or to direct it to a different viewing device. In this way an attacker can probe for weaknesses in the server implementations. The result might include unintended charges on the original customer's bill, as well as techniques to bypass parental controls on content. In this case, certain techniques can be used to defend against this. First, any purchase transactions can be stored in the firewalls and referenced to identify future attempts to replay the prior transactions from the same user. Second, various techniques in real-time can be implemented by the firewall (for example, randomly requesting retransmission of certain packets, or performing a simple challenge-response with the client) to thwart a possible replay.

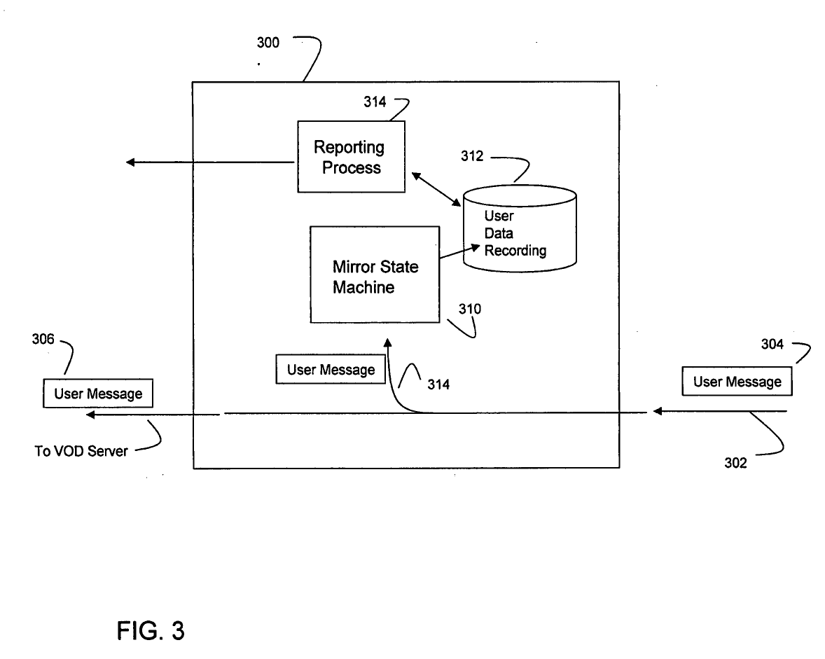

The above examples represent unusual messaging conditions that the VOD server would process, but would not necessarily detect, and/or report. Further, while one vendor may do so, other vendors may not. Thus, a service provider with a mix of vendor equipment would not have a consistent way to detect and report such conditions. A specialized application, (“firewall”) can be programmed to detect and report such conditions. One logical embodiment of such a firewall is shown in FIG. 3. In FIG. 3, firewall 300 is located so that messages 304 from the user over a facility 302 are received at an input port and copied by the firewall 300. The copying 314 of the message can be accomplished by duplicating the message into a buffer as the incoming messages are received. The message is sent to an output port, where the message 306 continues unchanged on the same or different facility to the VOD server (or other network server). The firewall 300 typically receives messages from a number of users, so that the processing may be replicated for a number of users. Further, the firewall only receives a copy of the message, and does not actively alter or generate messages on behalf of the message source.

The copied control message is delivered to a mirror state machine 310. This comprises a processor and memory. A state machine is created for a user and modified when control messages are received. It is called a ‘mirrored’ state machine in that it mimics the state machine of the VOD server, but there is no actual VOD system in the firewall or VOD service provided by the firewall. Thus, the firewall can be thought of as a virtual VOD service state machine. The mirrored state machine is defined in the context for a particular user, and the states are changed as per the protocol state transition definition based on control messages from the source. However, the state machine also maintains the logic to implement the various rules to detect unexpected conditions based on incoming messages. When abnormal conditions are detected, an indication of this is recorded in memory 312. The recordation can be a generic or specific in scope, and often includes a particular code value identifying one of several abnormal conditions. Thus, if no abnormal conditions are detected, the mirror state machines transitions as normal, but when an abnormal condition is detected, notation of the condition is recorded in the database 312.

The indications may or may not be linked or associated with a particular message source. The codes themselves may indicate the condition, such as: too many messages from a source within a given time period; too many unexpected messages from a source; duplicate service requests from a source; duplicate message types with different parameter values from a single source; etc.

Alternatively, the mirror state machine can simply record information for a user which is analyzed by a separate processing module (not shown). In either case, abnormal events for a user are record in the user data recording memory 312.

A reporting process 314 periodically retrieves the data from the database 312 for one or more users and reports the data to an intrusion detection system (not shown). The reporting process typically handles reporting data for a number of users associated with the firewall, and may also process the data from the number of users to by itself detect an abnormal condition. The reporting process could incorporate a number of parameters defining thresholds that allocate a severity of the abnormality. For example, if a large number of messages are received from a single viewer, a medium priority level could be assigned. If a large number of messages are received from a large number of viewers, a higher priority level may be assigned and reported.

The state machine for a user may be terminated in the mirror state machine when a user is inactive for a time period, or when a certain state is reached. For example, in FIG. 2, state 210 is reflective of not streaming any video (e.g., end of video has been reached). The state machine may be automatically terminated upon reaching this state, or upon reaching the state with no further messaging from the source for a time period. Any number of mechanisms can be created to delete state machines when the users are no longer active.

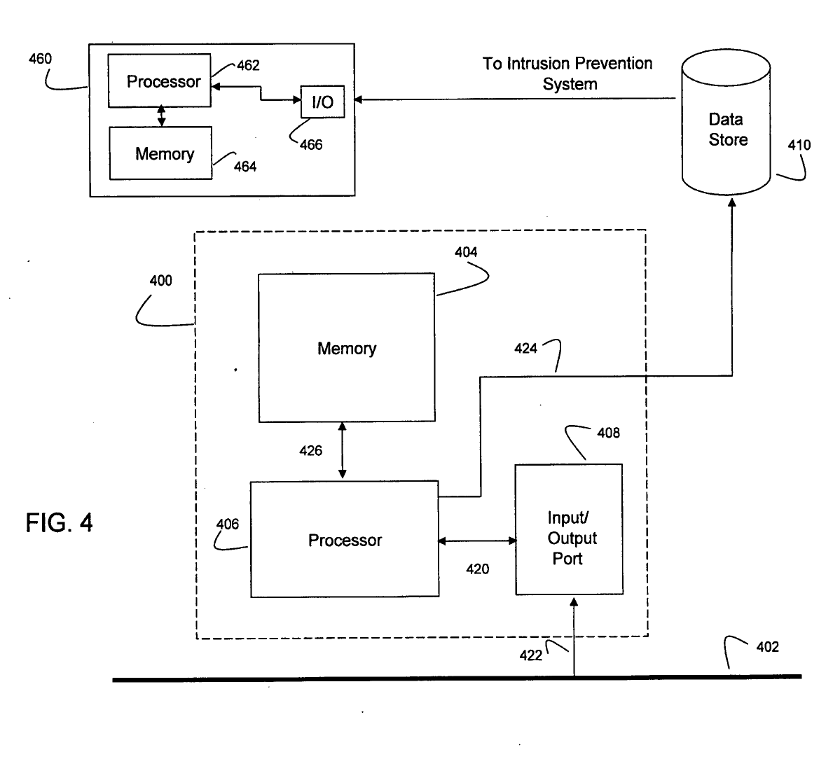

FIG. 4 illustrates one embodiment of the hardware architecture of the firewall. The firewall 400 in this embodiment comprises a general purpose computer augmented to interface to the physical facility 402 to copy messages from the user. The interface card 408 functions as an input/output port which interfaces 422 to the facility 402. The facility 402 could alternately represent a logical connection on a facility conveying the user's control messages. However, in either case, in one embodiment messages are only read by the firewall from the Internet from the user (or group of users). In other embodiments, the messages are first received by the firewall, processed, and only then relayed to the appropriate destination. In the first embodiment, the firewall only passively monitors the messages to the destination, while in the second embodiment, the firewall actively forwards the message to the destination. The firewall does not generate messages on behalf of the users. The messages are processed by a processor 406, which accesses memory 404 as necessary. The state machines for each respective user are typically stored in memory. Abnormal conditions may be reported to an external database 410, but in other embodiments the database 410 can be integrated into the firewall 400. The database also is accessible to an intrusion prevention system (“IPS”) 460. The IPS typically collects data from a plurality of firewalls, and the number of firewalls depends on the size of the firewall, e.g., how many users each firewall can accommodate. The IPS typically comprises a processor 462, memory 464 and I/O port 466 for interfacing with a network to obtain data from the various databases 410. Although FIG. 4 illustrates the firewall and the IPS as sharing a database, that is not always required.

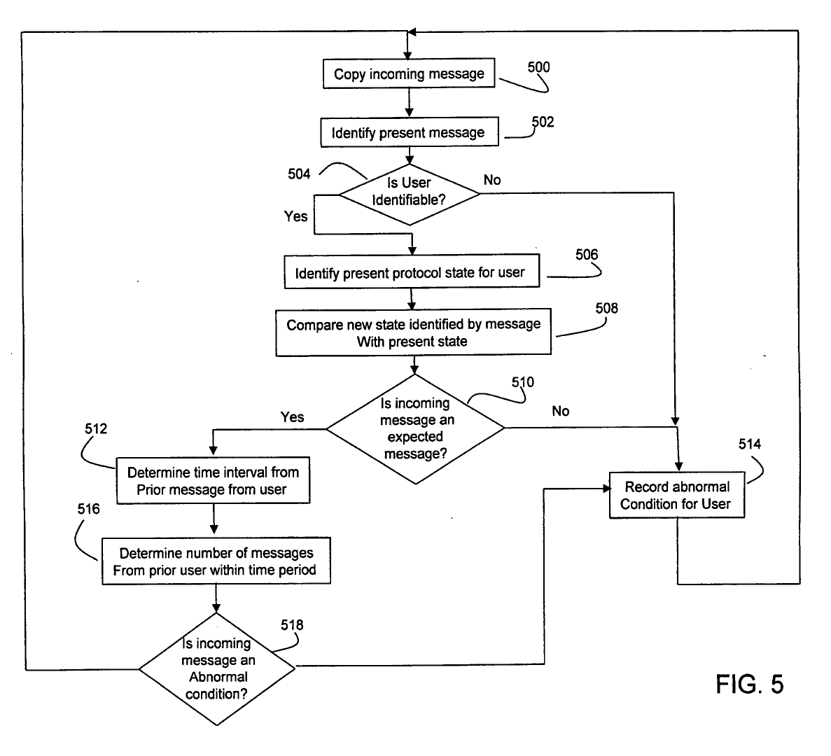

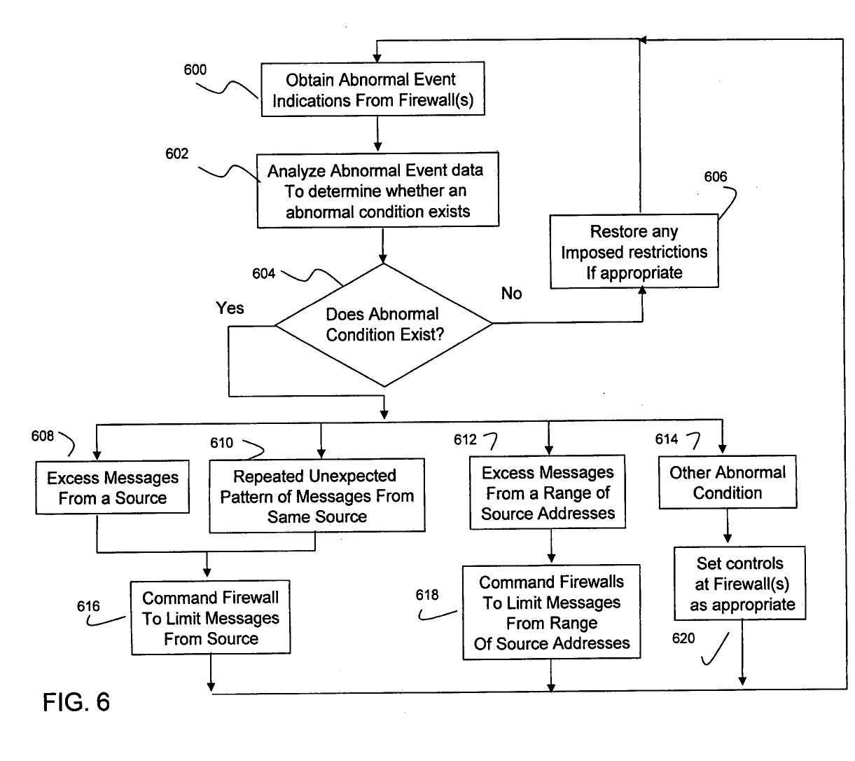

FIG. 5 illustrates one embodiment of the processing performed in the firewall. In FIG. 5, the process begins in step 500 with the firewall copying a control message from the facility from a user. This could be done in software, hardware, or a combination. Typically, the firewall will copy every application level message because it does not know the contents of the message until it analyzes the message, and this requires it to be first copied. In some embodiments the control messages may be conveyed on a particular connection, so all messages on the connection are copied. In other cases, messages may have to be parsed to a certain level to determine whether they should be copied.

In step 502 after the message has been copied, the message type is identified. The firewall is designed to analyze one or more application level protocols, and typically the particular protocol used (e.g., LSCP or RTSP) is known beforehand. For example, all copies of messages on a certain IP connection for a particular service or associated with a lower level protocol identifier are presumed to be of a certain protocol—e.g., RTSP or LSCP messages. Proprietary application protocols can be accommodated as well. In certain cases, a distinguishable protocol identifier may be present at the beginning of the message allowing identification of the protocol. Once the protocol is know, the syntax of the message is processed to determine which message is being sent by the user.

In step 504, the user identification is attempted based on the control message contents. The user is correlated to some other identifier, such as an IP address, transaction identifier, reference number, etc. Thus, the user is not typically identified as a person, but as a source of the messages. In some cases, messages will be received without a valid user identifier and the source cannot be identified or correlated with prior message sources. For example, the IP address may be of a range that is not allowed, or the message source has not previously been identified. For example, in some cases a reference number could be used to identify a particular transaction message sequence, and the reference number would be used to identify a message source. In the latter case, the reference number does not identify the source per se, but allows correlation of a given message with a previous message presumably from the same source. Certain messages in a transaction sequence are predicated on prior messages having established the transaction (e.g., an acknowledgement of a request). Thus, an acknowledgement of a request is usually correlated with the request in some manner. However, it is possible to receive an unrecognizable reference number, e.g., one that was not previously established. In such cases, there is no prior “user” to correlate the message with. This type of message may be indicative of a rogue device sending messages and guessing a valid reference number. If the user cannot be identified, then this by itself can be indicated as an abnormal event.

Assuming the user can be identified, the firewall in step 506 determines the present state machine and state for that user. In step 508, the message, which was identified, is compared with the protocol state machine for that user along with the current state to determine whether the message is an expected message. If, at step 510, the message is unexpected, then it may be indicated as an abnormal event for that user. The definition of which messages are defined as unexpected in a given state can be defined differently, and depends on the context. Certain unexpected messages may be “more unexpected” or more indicative a rogue device. However, in general, a message which does not change the current state of the state machine (or, alternatively, moves the state machine to the same state the state machine was previously in) is not a message which is acted upon and can be viewed as an unexpected message. Consequently, flexibility exists in defining for each state which messages result in reporting an abnormal indication. It is possible to report in the database an indication associated with every unexpected message, but in many cases certain unexpected messages are not likely to be significant, and will not be reported. Hence, if the event is recorded, it is considered an unexpected event. Note that merely recording an unexpected event for a user does not mean that the user device is a rogue terminal.

If the message from the user is an expected event, then the message is tested against various controls, shown here as steps 512 and 516. A variety of different types of controls can be defined, and can occur in different order. FIG. 5 illustrates only two such controls. The first control, in step 512, is a test to determine the time interval between the present message from the user and a prior message from the same user. This can be accomplished by recording a time stamp in a memory upon receipt of each message from a user. Hence, the time of receipt of the prior message is stored in memory such that whenever a present message is received, its time stamp value is determined and processed against the value stored in memory to determine the time interval. Alternatively, timer can be reset upon receipt of each message, but this may consume more resources. Regardless of how the time interval is determined, it can be used as a limit to enforce a certain minimum arrival time for messages.

Another test is shown in step 516. In this test, a count is maintained reflecting a number of messages received from that user within a time period. This can determined by processing a record of prior messages at certain time intervals (e.g., every minute, 10 minutes, etc.). Alternatively, time stamps for the last X number of messages from a user can be recorded, and a rate of messages received can be determined on a running basis. Regardless of how the rate of messaging is determined, this test can be used to enforce a limit of the number of messages in a time period from a user.

Other tests can be defined. For example, a counter can be maintained in a time period that is incremented when any message (expected or not) associated with the particular protocol regardless of the user. This value can be compared against a threshold to determine if an abnormally high volume of messages are received at the firewall. If an abnormal condition is detected, it is recorded in memory for that user. If the condition detected is not for a specific user (e.g., an overall message count for all users), then the indication can be recorded in the memory, but not associated with any specific user. Thus, it is possible to record both indications associated with a user (user specific indications) and indications that are associated with a number of users (generic indications).

The firewall can also maintain a list of sources, typically in the form of an IP address associated with the source device, which are either approved or disapproved. The list of IP addressed that is disapproved is called a ‘blacklist’ and represents message sources that for one reason or another, is considered a suspected rogue device or otherwise is not permitted to communicated with a server. Messages associated with a blacklisted source can be terminated in the firewall. That is, instead of merely copying messages transmitted to the server, the firewall performs an active role in determining whether the message will be allowed to pass to the server. Typically, the blacklist is used to screen all messages, regardless of message type or parameter values. In short, if the message is not allowed from a source, then regardless of the message details, it is not allowed. Other embodiments may define the blacklist specific to a message, but this is not a preferred embodiment. Typically, once an entity is on a blacklist, removal occurs either manually by administration personnel, or automatically by passage of time.

In another embodiment, the firewall can also maintain a ‘whitelist’ or list of approved message sources. Such a list can be used to screen all messages, but typically is used only to screen certain messages. For example, a message source may request a video, and that request results in the IP address of the message source to be included in the whitelist. In this case, the logic is that it is expected after the user has made a request, subsequent messages from the same source are likely to occur. Thus, one type of message puts the user on the whitelist, and allows the subsequent messages to pass. It would be unusual for a user to initiate certain messages (e.g., trick mode control functions) when they did not previously initiate a request for a movie. The whitelist processing would detect this scenario. The presence of a IP address on the whitelist is typically more dynamic, as sources are automatically added, and typically are removed with the passage of time. Alternative embodiments can explicitly add an IP address on the list in response to a user subscribing or otherwise requesting service and remove the IP address when the subscriber terminates services. However, such arrangements are based on an subscription model, as opposed to an ‘on-demand’ service model. However, the present invention can be adapted to either model.

The firewall typically serves a number of users, e.g., 100-10,000 users. Thus, as shown in FIG. 1, firewall 120b may serve a community of users 101. The number of users that can be supported depends on the memory, processing power, and other factors associated with the firewall. A state-dependent firewall can also implement multiple mirrored protocol state machines, depending on which services are desired to be monitored. In other embodiments, different firewalls may be utilized. For example, in FIG. 1, firewall 109 is used to mirror the application menu system messaging, whereas firewall 120a could be used to mirror the VOD server 112 messaging.

The firewall system reports its data to an intrusion prevention system 110. This system provides an overview of the various firewalls, and is able to process information not readily available to a single firewall. For example, assume a single service such as VOD involves 1) an application menu system and an associated first firewall, and 2) a VOD server with a separate firewall. The first firewall monitors messaging associated with the application menu system and the second monitor messaging associated with the trick mode control message. Both firewalls report abnormal messaging to the intrusion protection system.

The intrusion protection system (“IPS”) may process data from both firewalls to detect unusual messaging, which may or may not be indicative of rogues terminals. For example, assume that both firewalls are associated with a given geographical service area (e.g., town). A power outage occurs or an equipment failure occurs (such as an optical cable cut) which causes a service outage. It would not be unexpected when service is restored that the service provider would encounter a large number of requests. More specifically, if a VOD server briefly crashes and is restored, a large number of requests to re-establish VOD streams may expected. The IPS may be aware of outage and does not report the large number of service requires as an possible denial of service attack. On the other hand, the intrusion protection system may note an unusual increase in messaging from several firewalls (without any indication of a power failure or system outage), which individually may not be unusual, but when combined do represent an unusual condition.

As note before, the firewalls can record traffic levels independent of the protocol state machine. Thus, message counts can be recorded in the firewall for particular messages, regardless of the user source and regardless of the particular protocol being used. These message counts can then be reported by the firewall to the intrusion protection system on a periodic basis. Alternatively, the intrusion protection system can poll the firewalls to obtain this data. The intrusion protection system can monitor specific messages types and report them. For example, requesting a VOD movie by a user is indicative of an incremental user demand for network services which consume capacity, whereas user messages to pause or fast forward a selected movie may not be viewed as increasing a demand for network resources. Specifically, the initial request to stream a movie impacts the network loading more so, and the impact of rogue requests for initiating a movie are more significant than control messages requesting certain other functions. Hence, individually monitoring VOD requests as a separate category may be individually monitored by the firewall and reported to the IPS. The IPS can maintain a historical record of prior usage, and compare current network usage against the historical average. This average can be by day of week, time of day, serving area, or combinations thereof.

It is well known that computer viruses can be designed to spread and infect a number of computers on a network, and that the virus itself may define a date and time to coordinate an attack. Thus, the virus lies dormant and then initiates an attack characterized by initiating messages to a common target at the same time. By maintaining a historical average for a given time of day, the intrusion protection system can detect an increase in traffic and compare that volume against a historical volume of traffic to determine whether an abnormal condition is encountered. For example, it is expected that VOD requests on a weekend night are higher than Monday morning. Thus, if only a single threshold were defined, it would have to accommodate peak periods. Using an historical average for a time of day or day of week could provide an early indication of an abnormal condition that would otherwise not be detected. The threshold for determining an excess traffic volume could be defined as a percentage or other value above a past value.

The intrusion protection system can be capable of shutting down gateways, servers, or other devices to mitigate the attack or abnormal condition. In many instances, an attack will involve a certain source or set of sources. The sources may have a certain IP address or other common aspect such as all initiating the same type of messaging. The IPS can instruct specific equipment to limit or otherwise reduce traffic. Alternatively, the IPS may be incorporated into a network operations center and allow human intervention to decide what responsive action should be taken.

Specifically, the IPS can send a command to one or more of the firewalls instructing the firewall to block a certain type of message from a specific source, or from any source. The IPS can also command a firewall to block all messages from a source, or a set of sources (e.g., a range of IP addresses). The IPS can also send a command for the firewall to block messages for a period of time (in conjunction with the above commands). The period of time can be indicated as a begin/end time, as well as for a duration beginning upon receipt (e.g., for the next 15 minutes).

One embodiment of the process followed by the IPS is shown in FIG. 6. In FIG. 6, the process begins with the IPS collecting data from the various firewalls in step 600. The IPS can poll, request, or receive notifications from the firewalls in a variety of ways. The data typically includes the nature of the abnormal event, and possibly a source address. The nature of the event can be indicated by a code representing a generic or a specific type of event.

After obtaining the event data, the IPS then analyzes the abnormal event data based on various rules in step 602. The rule may be based on the number, type, or rate of messaging. The analysis may correlate data from various firewalls along with the types of events detected. It is possible that a series of indications from different firewalls may not constitute an abnormal condition, and if such, then step 606 may occur, which resets any previously imposed conditions. The IPS may opt to retain such imposed conditions even after no further abnormal conditions are observed.

If the IPS detects an abnormal condition, it typically will send an alarm or reporting message to a network operation center, and will also instruct the firewall(s) involved to take certain action. FIG. 6 illustrates only a few of the possible actions, such as determining in step 608 that an excess number of messages have been received from a source. This could be determined by an absolute number of messages during a time period, or that a rate of messages has been exceeded. The condition could also be that a number of repeated unexpected messages are received from a source in step 610, or that multiple sources are generated an excess of messages in step 612. Other conditions may be detected as shown in step 614.

Based on the condition detected, the IPS may generate the appropriate command to the firewall(s), including limiting messages from a source in step 616, limiting messages from a range of sources addresses in step 618, or other steps as appropriate in step 620. After the IPS takes appropriate action, it returns to collecting data from the firewalls in step 600 and analyzing the data to determine if the abnormal condition exists.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended listing of inventive concepts. Although specific terms are employed herein, they are used in a generic and descriptive sense only and not for purposes of limitation.

That which is claimed:

1. A method for detecting an abnormal condition in an IPTV network, comprising the steps of:
copying an IPTV control message from an IP network into a firewall system comprising a processor, said control message conveyed on a connection in the IPTV network wherein said connection conveys one or more messages from a IPTV message source to a server, said server configured to provide a service on said IPTV network;
ascertaining in the processor a message type of the control message wherein the message type is associated with a real time control protocol for controlling said service, said processor ascertaining a message source of the message;
determining a state machine stored in a memory accessible by said processor, said state machine previously created by the processor based at least one a previous message generated from the source, said state machine having a current state;
using the current state of the state machine to determine whether the control message from the source is an expected event; and
recording an indication in a database if the message from the source is not an expected event wherein said indication is associated with the source and said indication signifies detection of an unexpected event.

2. The method of claim 1 wherein if said message from the source is an expected event, said processor increments a counter associated with said user and determines whether said counter exceeds a threshold value stored in memory.

3. The method of claim 2 wherein said counter indicates a number of messages received from said source during a time period.

4. The method of claim 1 wherein said database is one of a plurality of databases, and said indication in the database is retrieved from said database periodically by a second processor.

5. The method of claim 4 further comprising the steps of:
receiving said indication in an intrusion detection system comprising the second processor and a second memory; and
analyzing said indication from said database in said second processor in conjunction with other indications stored in said second memory received from other databases to determine an abnormal condition in the IPTV network.

6. The method of claim 1 wherein the processor updates the state machine stored in memory by identifying a new current state of the state machine.

7. The method of claim 6 wherein the new current state of the state machine is determined by using the message type.

8. A method for reporting an abnormal condition in an IPTV network, comprising the steps of:
copying a IPTV control message from a connection conveying one or more messages from a source into a processor;
ascertaining in the processor a message type of the control message wherein the message type is associated with a real time control protocol;
ascertaining the source originating the control message by the processor analyzing the control message;
determining an indication associated with a prior control message originating from the source is not stored in a memory; and
determining that an abnormal condition exists based on the lack of the indication associated with the prior control message stored in the memory.

9. A method for reporting an abnormal condition in an IPTV network, comprising the steps of:
copying a IPTV control message from a connection conveying one or more messages from a source into a processor;
ascertaining in the processor a message type of the control message wherein the message type is associated with a real time control protocol;
ascertaining the source originating the control message by analyzing the control message in the processor;
retrieving from a memory an indication of a prior control message originating from the source; and
determining by using the control message and the indication of the prior control message that an abnormal condition exists.

10. The method of claim 9 wherein said processor uses a time interval between receipt of said prior message and receipt of said control message to determine said abnormal condition exists.

11. The method of claim 8 further comprising the step of:
recording an indication in said database associated with said source, said indication signifying detection of an abnormal event.

12. A system for detecting an abnormal condition in an IPTV network comprising:
a plurality of firewalls, each firewall comprising:
an input/output device configured to copy a control message from a IPTV connection conveying IPTV control messages from a source, said control message one of a plurality of message types associated with a real time IPTV control protocol, said control message including a source indication and a destination indication,
a first processor configured to receive said control message from said input/output device, said processor configured to ascertain a message type of said control message, said processor configured to ascertain the source indication of said control message, and
a memory configured to store a state machine and a current state associated with the source identified by said source indication, said memory configured to provide said current state to said first processor,
wherein said first processor is configured to ascertain using said state machine and said current state whether said control message indicates an abnormal condition associated with said source, said processor configured to record an indication in a database associated with said source if said control message indicates an abnormal condition; and
an intrusion detection system comprising:
a second processor configured to receive a plurality of indications from a plurality of firewalls, said second processor configured to process said plurality of indications to determine whether an abnormal condition exists in said IPTV network,
a second memory connected to said second memory for storing said plurality of indications, and
a plurality of communication links connecting said second processor to said first processor used to convey said plurality of indications to said instruction detection system.

13. The system of claim 12 wherein said first processor is configured to record in said database a new current state associated with said source.

14. The system of claim 12 wherein said first processor determines said abnormal condition exists by determining said control message is the same as a previously received control message from said source.

15. The system of claim 12 wherein said firewall precludes said control message from being transmitted to a server.

16. The system of claim 12 wherein the second processor is configured to transmit a command over one of the plurality of communication links to one or more firewalls to block a certain type of control message from a source.

17. The system of claim 12 wherein the second processor is configured to transmit a command over one of the plurality of communication links to one or more firewalls to block messages for a period of time.

18. A system for detecting an abnormal condition in an IPTV network, comprising:
a firewall comprising:
an input/output device configured to copy a first and second control message from an IPTV connection conveying IPTV control messages from a source wherein said first and second control message include a source indication and a destination indication, said first control message having a first type of one of a plurality of message types associated with a real time IPTV control protocol, said second control message having a second type;
a first processor configured to receive said first and second control message from said input/output device, said first processor configured to ascertain the first type of said first control message, said first processor configured to ascertain the source indication of said control message, said first processor configured to record a first indication associated with said source indication if said message type is of a first type,
said first processor further configured to ascertain the second type of said second control message, said first processor retrieve said first indication and determine whether said second control message is an expected condition given said first message type; and
a memory configured to store a first indication and said source indication, said memory configured to provide said first indication to said first processor upon request,
wherein said processor is configured to record in a database an abnormal condition indication associated with said source based on said second control message.

19. The system of claim 18 wherein said first processor determines an abnormal condition exists based on said second control message being the same as the first control message.

20. The system of claim 18 wherein the first processor determines an abnormal condition exists based on the second control message being received with a time period from said first control message.
